(19) United States
(12) Patent Application Publication
(10) Pub. No.: US 2025/0251553 A1
(43) Pub. Date: Aug. 7, 2025

(54) OPTICAL DEVICE AND CONNECTION STRUCTURE FOR OPTICAL CONNECTOR

(71) Applicant: FURUKAWA ELECTRIC CO., LTD., Tokyo (JP)

(72) Inventors: Shosuke Ikeda, Tokyo (JP); Yuki Fujimaki, Tokyo (JP); Kengo Watanabe, Tokyo (JP); Tsunetoshi Saito, Tokyo (JP)

(21) Appl. No.: 19/039,334

(22) Filed: Jan. 28, 2025

(30) Foreign Application Priority Data
Feb. 5, 2024 (JP) 2024-015671
Aug. 1, 2024 (JP) 2024-125685

(51) Int. Cl. G02B 6/38

(52) U.S. Cl. CPC G02B 6/3886; G02B 6/3885

(57) ABSTRACT

An optical waveguide, which is to be optically connected to an optical connector to be connected, is disposed at a substantial center of a width direction of an optical connector. Also, magnets are disposed on both sides of the width direction of the optical connector with the optical waveguide in between. Polarities of the magnets disposed adjacent to each other in the one optical connector and in the other optical connector, which is adjacent to the one optical connector, are different from one another. When connecting the one optical connector to another optical connector, the magnets of the one optical connector and magnets of the other optical connector can attract each other to be connected, and it is also possible to cause the magnets of the other optical connector adjacent to the magnets of the one optical connector to repel the magnet of the other optical connector.

### TECHNICAL FIELD

The present invention relates to an optical device and the like having a connector that can be optically connected to a connection target.

### BACKGROUND

In the fields of photoelectric fusion (CPO) and silicon photonics (SiP), an optical connection mechanism for connecting a photonic integrated circuit (PIC) etc. to optical fibers is to be used. For example, a PIC (a photonic integrated circuit) such as SiP and integrated circuits and the like are mounted on a substrate, and optical fibers having connectors for connection with other devices are connected to the photonic integrated circuit.

When building such the optical connection structure, the substrate and the photonic integrated circuit are connected to each other through a reflow process, for example. However, if a large number of the optical fibers attached with the connectors as above are connected to the substrate, handling becomes complicated, resulting in poor handling performance. Also, self-weight of the connectors and pulling tension of the optical fibers may apply stress onto joint portions between the optical fibers and the photonic integrated circuit and may damage the joint portions. In addition, the optical fibers and the connectors are to have heat resistance to withstand a reflow.

In contrast, Japanese Unexamined Patent Application Publication No. 2016-90614 (JP-A-2016-90614) has proposed a method in which optical wiring members are fixed by adhesion to stubs that are fixed onto a photonic integrated element after a reflow process. In Japanese Unexamined Patent Application Publication No. 2016-90614 (JP-A-2016-90614), materials having excellent heat resistance are selected for the photonic integrated element, prisms, adhesive, and so on to withstand the reflow process. Also, the optical fibers etc. are then connected, and this can suppress deterioration by heat of the optical fibers and connectors.

However, when connecting a large number of optical fibers to a substrate or the like as mentioned above, each of the optical fibers is to be aligned and fixed with adhesive. For this reason, the connection operation takes rather a long time. In addition, the already connected optical fibers may get in the way of alignment and connection operation of other optical fibers that follow, which may cause deterioration of the workability.

In contrast, a structure in which optical fibers and an optical device can be easily attached and detached have been proposed. FIG. 23 is a schematic view showing an optical device 100. The optical device 100 includes multiple optical connectors 101a that are provided side by side, and each of the optical connectors 101a includes an optical connector 101b at one end and an optical fiber 103 having an optical connector 105 is connected to the other end. That is, the optical connector 101a and the optical connector 101b are connected to each other.

When considering further dense-packaging in such the optical device 100, as a connection structure for the optical connectors 101a and 101b, an optical connection structure using magnets, which can be easily attached and detached and can be easily downsized, have been proposed. In this way, the connection structure is small in size compared to a connection structure using mechanical latches or the like and optical fibers can be connected easily after the reflow process, which facilitates handling.

FIG. 24 is a schematic view showing a connection structure between the optical connector 101a and the optical connector 101b. In the optical connector 101a, a pair of magnets 107a are disposed at symmetrical positions with an optical waveguide in between. Meanwhile, in the optical connector 101b, a pair of magnets 107b are disposed at symmetrical positions with the optical fiber 103 in between. In the illustrated example, the optical connector 101a has N poles disposed on a side facing the optical connector 101b, and the optical connector 101b has S poles disposed on a side facing the optical connector 101a. Thus, the both attract each other and the optical connectors 101a and 101b are connected.

However, because of the dense-packaging as mentioned above, spaces between the adjacent optical connectors 101a are getting extremely narrow. Thus, as shown in a lower part of the FIG. 24, there may be a case in which the optical connector 101b is connected incorrectly to, by straddling, the adjacent optical connectors 101a. This may cause deterioration of workability, such as redoing the connecting operation.

### SUMMARY OF THE DISCLOSURE

The present invention was made in view of such problems. It is an object of the present invention to provide an optical device and an optical connector connection structure that excel in connection operations.

To achieve the above object, a first aspect of the present invention is an optical device including a plurality of optical connectors that are provided side by side.

Magnets are disposed in each of the optical connectors, and polarities of the magnets that are disposed adjacent to each other in the one optical connector and in the other optical connector, which is adjacent to the one optical connector, are different from one another, such that, when connecting the one optical connector to an optical connection terminal to be connected, the magnets of the one optical connector and terminal-side magnets of the optical connection terminal to be connected can attract each other to be connected and, at the same time, the magnets of the other connector, which are adjacent to the magnets of the one connector, and the terminal-side magnets of the optical connection terminal to be connected can repel each other.

With respect to a side-by-side direction of the optical connectors, the polarities of the magnets on one side of the optical connector may be different from the polarities of the magnets on the other side of the optical connector.

The magnets may be disposed, respectively, on both sides of the side-by-side direction of the optical connectors.

The magnets may be disposed, respectively, at an upper part and a lower part of a height direction that is perpendicular to the side-by-side direction of the optical connectors.

The optical connector may be provided with guide mechanisms for the optical connection terminal to be connected such that the guide mechanisms face each other in the side-by-side direction of the optical connectors or in a direction perpendicular to the side-by-side direction with a center of the optical connector in between.

The optical connector may be provided with a hole into which a guide pin or a boss of the optical connection terminal to be connected can be inserted.

The magnets may be fixed to the optical connector with an elastic member formed of a soft magnetic body.

The optical connector may include a positioning member having guide mechanisms for a connection target, a lens array that is to be fixed to the positioning member, and an optical waveguide member that is to be optically connected to the lens array.

A yoke may be fixed to the positioning member.

The magnets may be samarium-cobalt magnets.

A hole having a predetermined depth may be formed in the optical connector from a rear side toward a front face, which is a joining face with the optical connection terminal to be connected, the magnet may be inserted into the hole, and the magnet may be fixed such that a front end face of the magnet is at a position that is pulled back from the front face of the optical connector toward an inner side of the optical connector for a predetermined distance.

A distance between the front end face of the magnet and the front face of the optical connector may be between 0.01 mm and 0.5 mm.

An adhesive applying hole that communicates from an outer periphery surface through to the hole of the optical connector may be formed, and the magnet and the optical connector may be fixed to each other with adhesive at the adhesive applying hole.

A concave portion may be formed on the outer periphery surface of the optical connector, and the magnet may be fitted into the concave portion to be fixed.

A material forming the optical connector may be made of magnetic resin and a main body of the optical connector itself may be made of a magnet, where polarities of the one optical connector and polarities of the other optical connector that is adjacent to the one optical connector may be different from each other.

According to the first aspect of the present invention, the polarities of the magnets disposed adjacent to each other in the one optical connector and in the other optical connector, which is adjacent to the one optical connector, are different from one another. Thus, when connecting the optical connection terminal to the one optical connector, the magnets of the other connector and the magnets of the optical connection terminal can repel each other. Thus, incorrect connection can be easily suppressed.

For example, by making the polarities of the magnets on the one side of the optical connector different from the polarities of the magnets on the other side of the optical connector with respect to the side-by-side direction of the optical connectors, the optical connector of the optical device can be connected with certainty to the optical connection terminal without changing arrangements of the respective terminal-side magnets on the side of the optical connection terminal for every optical connection terminal.

At this time, by disposing the magnets respectively on both sides of the side-by-side direction of the optical connector, the optical connectors can be connected with certainty on both sides of the side-by-side direction with respect to the optical waveguide.

Also, the magnets are disposed, respectively, on the upper and lower parts of the height direction that is perpendicular to the side-by-side direction of the optical connectors, and thus the optical connectors can be connected with certainty on both sides of the height direction with respect to the optical waveguide.

Also, the guide mechanisms for the optical connection terminal to be connected are provided such that the guide mechanisms face each other in the side-by-side direction of the optical connectors or in the direction perpendicular to the side-by-side direction with the center of the optical connector in between. This facilitates positioning of the optical connection terminal and suppresses tilting or the like of the optical connection terminal.

Similarly, the optical connector is provided with a hole into which the guide pin or the boss of the optical connection terminal to be connected can be inserted, and this facilitates positioning of the optical connection terminal and suppresses tilting etc. of the optical connection terminal.

Also, by fixing the magnets to the optical connector with the elastic member formed of a soft magnetic body, the elastic member can function as a yoke for the magnets, which can reduce interference between the magnets of the adjacent optical connectors.

Also, if the optical connector includes the lens array, the plurality of optical fibers can be connected efficiently and simultaneously, and, at the same time, beams are enlarged by the lens array, thereby enlarging tolerance with the facing optical connection terminal to be connected.

Also, fixing the yoke to the positioning member can increase attractive force of the magnets.

Also, if the magnets are samarium-cobalt magnets, demagnetization during the reflow process can be suppressed.

Also, the hole having the predetermined depth is formed in the optical connector from the rear side toward the front face and the magnet is inserted into the hole and fixed. This facilitates positioning and fixing of the magnets. Also, the front end face of the magnet is at a position that is pulled back from the front face of the optical connector toward the inner side of the optical connector for the predetermined distance. In this way, the attractive force between the magnets of the optical connector and the terminal-side magnets of the connection target can be adjusted.

At this time, the distance between the front end face of the magnet and the front face of the optical connector is between 0.01 mm and 0.5 mm. In this way, the attractive force with the connection target can be appropriately set, thereby suppressing impact at the time of connection.

Also, by forming the adhesive applying hole that communicates from the outer periphery surface through to the hole of the optical connector, the magnet and the optical connector can be fixed with each other easily by applying adhesive through the adhesive applying hole.

Also, forming the concave portion on the outer periphery surface of the optical connector and fitting the magnet into the concave portion facilitates positioning of the magnets.

Also, if the material itself forming the optical connector is made of magnetic resin, the main body itself of the optical connector can be formed of a magnet. Thus, there is no need to separately fix magnets to the main body. Even in such the case, by making the polarities of the adjacent optical connectors different from one another, when connecting the optical connection terminal to the one optical connector, it is possible to make the magnets of the other optical connector repel the magnets of the optical connection terminal.

A second aspect of the present invention is an optical connector connection structure between the optical device according to the first aspect of the present invention and an optical connection terminal, in which the magnets of each of the optical connectors and terminal-side magnets of the optical connection terminal to be connected are attracted to each other to be connected.

With respect to a width direction of the optical connection terminal to be connected, a polarity of the terminal-side magnet on one side of the connection terminal affecting a rear side of the optical connection terminal may be the same as a polarity of the terminal-side magnet on the other side of the optical connection terminal affecting a front side of the connection terminal.

The magnets may be samarium-cobalt magnets, and the terminal-side magnets may be neodymium magnets.

When the respective optical connectors are connected to each other, there may be gaps formed between the magnets and the terminal-side magnets that attract each other so as not to be in contact with each other.

A hole having a predetermined depth may be formed in the optical connection terminal from a rear side toward a front face, which is a joining face with the optical connector, the terminal-side magnet may be inserted into the hole, and the terminal-side magnet may be fixed such that a front end face of the terminal-side magnet is at a position that is pulled back from the front face of the optical connection terminal toward an inner side of the optical connection terminal for a predetermined distance.

A distance between the front end face of the terminal-side magnet and the front face of the optical connection terminal may be between 0.01 mm and 0.5 mm.

An adhesive applying hole that communicates from an outer periphery surface through to the hole of the optical connection terminal may be formed, and the terminal-side magnet and the optical connection terminal may be fixed to each other with adhesive at the adhesive applying hole.

A concave portion may be formed on the outer periphery surface of the optical connection terminal, and the terminal-side magnet may be fitted into the concave portion to be fixed.

A material forming the optical connection terminal may be made of magnetic resin and a main body of the optical connection terminal may be formed of a terminal-side magnet.

A guide pin or a boss may be provided on each of one ends of the optical connector and the optical connection terminal, a hole into which the guide pin or the boss can be inserted may be formed on each of the other ends of the optical connector and the optical connection terminal, and an insertion length of the guide pin or the boss in the hole may be 0.05 mm or more and 0.60 mm or less.

A difference between an outer diameter of the guide pin or the boss and an inner diameter of the hole may be 0.005 mm or less.

According to the second aspect of the present invention, an optical connector connection structure that excels in handling and can suppress incorrect connections can be obtained.

Also, with respect to the width direction of the optical connection terminal to be connected, the polarities of the terminal-side magnets on respective sides are different from one another. This can suppress attraction between the adjacent optical connection terminals when connected to the optical connector of the optical device.

Also, if the magnets are samarium-cobalt magnets, demagnetization during the reflow process can be suppressed. Also, if the terminal-side magnets are neodymium magnets, it is less expensive compared to samarium-cobalt magnets.

Also, the magnets are not in contact with each other when the optical connectors are connected, and this makes the optical connectors in a connection state as designed, which enables to achieve the stable connection state and thereby achieving desirable optical coupling.

Also, by forming the hole having the predetermined depth in the optical connection terminal from the rear side toward the front face and inserting the terminal-side magnet into the hole, the terminal-side magnet can be fixed easily. Also, the front end face of the terminal-side magnet is at the position that is pulled back from the front face of the optical connection terminal toward the inner side of the optical connection terminal for the predetermined distance, and this can adjust attractive force between the terminal-side magnets and the magnets of the optical connector.

At this time, the distance between the front end face of the terminal-side magnet and the front face of the optical connection terminal is between 0.01 mm and 0.5 mm. In this way, the attractive force between the optical device and the connectors can be set appropriately, thereby suppressing impact at the time of connection. For example, even if samarium-cobalt magnets, which are extremely fragile magnets, are used, damage to the magnets can be suppressed by avoiding collision between the magnets.

Also, by forming the adhesive applying hole that communicates from the outer periphery surface through to the hole of the optical connection terminal, the terminal-side magnet and the optical connection terminal can be easily fixed to each other by applying adhesive through the adhesive applying hole.

Also, forming the concave portion on the outer periphery surface of the optical connection terminal and fitting the terminal-side magnet into the concave portion facilitates positioning of the magnets.

Also, if the material itself forming the material forming the optical connection terminal is made of magnetic resin, the main body of the optical connection terminal itself can be formed of the terminal-side magnet. Thus, there is no need to separately fix terminal-side magnets to the main body.

Also, in a case in which the optical connector and the optical connection terminal are connected by using the guide mechanisms of the guide pin or the boss with the hole, the insertion length of the guide pin or the boss in the hole is to be 0.05 mm or more and 0.60 mm or less. This makes sure that the guide pin or the boss is inserted into the hole with certainty. Thus, tilting or the like due to imperfect insertion of the guide pin or the boss into the hole can be suppressed.

Also, in such the case, by making the difference between the outer diameter of the guide pin or the boss and the inner diameter of the hole 0.005 mm or less, precision of positioning can be improved.

The present invention can provide an optical device and an optical connector connection structure that excel in connection operations.

### BRIEF DESCRIPTION OF DRAWINGS

FIG. 1A is a schematic plan view of optical connectors 3 in an optical device 1.

FIG. 1B is a view taken in a direction of an arrow A in FIG. 1A.

FIG. 2 is a view showing a state in which optical connectors 9 are connected to the optical connectors 3.

FIG. 3 is a view showing an optical connector connection structure 20b.

FIG. 4A is a view showing a layout of magnets in the optical connector 3.

FIG. 4B is a view showing a layout of magnets in the optical connector 3.

FIG. 4C is a view showing a layout of magnets in the optical connector 3.

FIG. 5 is a view showing a state in which optical connectors 9a and 9b are connected to optical connectors 3a and 3b.

FIG. 6A is a view showing a state in which the optical connector 9 is connected to the optical connector 3 using a guide 15.

FIG. 6B is a view showing a state in which the optical connector 9 is connected to the optical connector 3 using the guide 15.

FIG. 6C is a view showing a state in which the optical connector 9 is connected to the optical connector 3 using the guide 15.

FIG. 6D is a view showing a state in which the optical connector 9 is connected to the optical connector 3 using the guide 15.

FIG. 7A is a front view of an optical connector 9c.

FIG. 7B is a view showing a state in which the optical connector 9c is connected to an optical connector 3c.

FIG. 7C is a view showing a state in which the optical connector 9c is connected to the optical connector 3c.

FIG. 7D is a view showing a state in which the other optical connector 9c is connected to the optical connector 3c.

FIG. 8A is a view showing a method for fixing magnets 5a and 5b.

FIG. 8B is a view showing a method for fixing the magnets 5a and 5b.

FIG. 9A is a view showing another method for fixing the magnets 5a etc.

FIG. 9B is a view showing another method for fixing the magnets 5a etc.

FIG. 10A is a view showing another method for fixing the magnets 5a etc.

FIG. 10B is a view showing another method for fixing the magnets 5a etc.

FIG. 11A is a view showing another method for fixing the magnets 5a etc.

FIG. 11B is a view showing another method for fixing the magnets 5a etc.

FIG. 12A is a view showing another method for fixing terminal-side magnets 11a etc.

FIG. 12B is a view showing another method for fixing the terminal-side magnets 11a etc.

FIG. 12C is a view showing another method for fixing the terminal-side magnets 11a etc.

FIG. 13A is a view showing another method for fixing the magnets 5a etc.

FIG. 13B is a view showing another method for fixing the magnets 5a etc.

FIG. 13C is a view showing another method for fixing the terminal-side magnets 11a etc.

FIG. 14 is a view showing an example in which the optical connectors 3 and 9 themselves are magnets.

FIG. 15A is a view showing a state in which an optical connector 9d is connected to an optical connector 3d.

FIG. 15B is a front view of the optical connector 3d.

FIG. 16A is a view showing a state in which the optical connector 3d having a yoke 24a and the optical connector 9d having a yoke 24b are connected.

FIG. 16B is a view showing a shape of the yoke 24a.

FIG. 16C is a view showing another shape of the yoke 24a.

FIG. 17A is a view showing dimensions of a boss 17a and a hole 19.

FIG. 17B is a view showing dimensions of the boss 17a and the hole 19.

FIG. 18A is a front view of an optical connector 3e.

FIG. 18B is a front view of an optical connector 9e.

FIG. 18C is a front view of the optical connector 9e.

FIG. 19A is a view showing a state in which an optical connector 9e is connected to an optical connector 3e.

FIG. 19B is a view showing a state in which the optical connector 9e is connected to the optical connector 3e.

FIG. 19C is a cross-sectional view taken along F-F line in FIG. 19B.

FIG. 20 is a view showing a state in which protection members 29 are attached to the optical device 1.

FIG. 21 is an enlarged view showing a state in which the protection members 29 are attached.

FIG. 22 is an enlarged view showing a state in which the other protection members 29 are attached.

FIG. 23 is a schematic view showing a connection structure between a conventional optical device 100 and optical fibers 103.

FIG. 24 is an enlarged schematic view of the connection structure between the conventional optical device 100 and the optical fibers 103.

### DETAILED DESCRIPTION

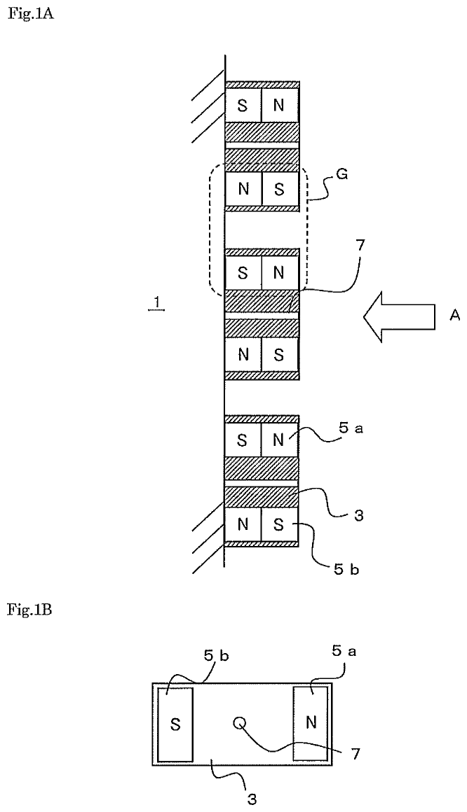

Hereinafter, an optical connection terminal according to an embodiment of the present invention will be described. FIG. 1A is a view showing optical connectors 3 that are provided side by side in an optical device 1, and FIG. 1B is a view from a connecting direction of the optical connectors 3 (which is a view taken in a direction of an arrow A in FIG. 1A and sometimes referred to as a front view hereafter). In FIG. 1A, cross-sectional views of the optical connectors 3 taken in a horizontal direction are shown.

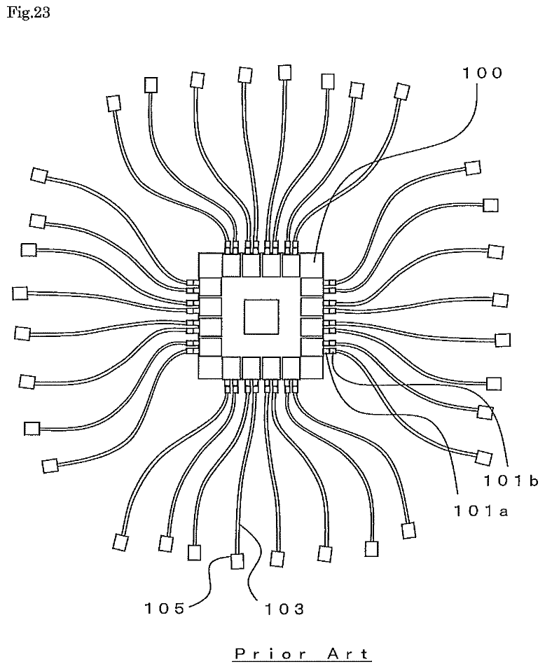

The optical device 1 includes a substrate and various types of chips (of which illustrations are omitted) installed on the substrate. Similarly to the optical device 100 shown in FIG. 23, the plurality of optical connectors 3 are provided side by side in a circumferential direction around the optical device 1. An optical waveguide 7 that is to be optically connected to an optical connector to be connected is provided at a substantial center of a width direction of the optical connector 3 (a side-by-side direction of the optical connectors 3 is to be the width direction). Also, with respect to the width direction of the optical connector 3, magnets 5a and 5b are disposed on both sides, respectively, with the optical waveguide 7 in between. That is, the optical connector 3 has at least a pair of magnets.

In each optical connector 3, polarities of the magnet 5a on one side of a width direction of the optical waveguide 7 (e.g., on an upper side in FIG. 1A) are opposite from polarities of the magnet 5b on the other side of the width direction of the optical waveguide 7 (e.g., on a lower side in FIG. 1A). For example, as shown in FIG. 1B, the magnet 5a is disposed such that its N pole faces toward the connecting direction of the optical connector 3 (the right direction in FIG. 1A), and the magnet 5b is disposed such that its S pole faces toward the connecting direction of the optical connector 3 (the right direction in FIG. 1A).

Thus, as shown in FIG. 1A, polarities of the magnets that are disposed adjacent to each other of the one optical connector 3 and the other optical connector 3 that is adjacent to the one optical connector 3 (e.g., as in G section in the drawing, the magnet 5b of the upper optical connector 3 in FIG. 1A and the magnet 5a of the middle optical connector 3 in FIG. 1A) are different from one another. That is, when viewed from the connecting direction of the optical connectors 3, polarities of the respective magnets of the plurality of optical connectors 3 are repeated alternating between N-S-N-S-N . . . in the side-by-side direction of the optical connectors 3.

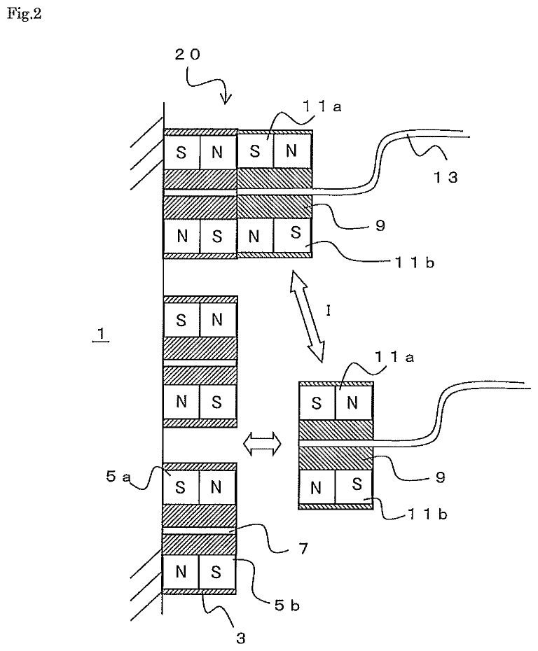

FIG. 2 is a view showing an optical connector connection structure 20 in which the optical device 1 including the optical connectors 3 is connected to an optical connector 9, which is an optical connection terminal to be connected to the optical connector 3. The optical connector 9 is connected to one end side of an optical fiber 13, and another optical connector (not shown in the drawing) is connected to the other end side of the optical fiber 13. An internal structure of the optical connector 9 is not specifically limited.

With respect to a width direction of the optical connector 9, terminal-side magnets 11a and 11b are disposed on both sides of the optical fiber 13, respectively. That is, the optical connector 9 has at least a pair of terminal-side magnets. Also, in the optical connector 9, polarities of the terminal-side magnet 11a on one side of the width direction (e.g., on an upper side in FIG. 2) are opposite from polarities of the terminal-side magnet 11b on the other side of the width direction (e.g., on a lower side in FIG. 2). For example, the terminal-side magnet 11a is disposed such that its S pole faces toward a connecting direction of the optical connector 9 (the left direction in the drawing), and the terminal-side magnet 11b is disposed such that its N pole faces toward the connecting direction of the optical connector 9 (the left direction in the drawing).

When the optical connector 3 and the optical connector 9 face each other, the magnets 5a and 5b of the optical connector 3 and the terminal-side magnets 11a and 11b of the optical connector 9 are disposed at positions facing each other, respectively. Thus, the magnet 5a and the terminal-side magnet 11a attract each other, and the magnet 5b and the terminal-side magnet 11b attract each other. In such the state, the optical waveguide 7 and the optical fiber 13 are disposed at the same corresponding position so that the optical connector 3 and the optical connector 9 are optically connected. In this way, the optical connector 9 can be easily attached to or detached from the optical connector 3.

On the other hand, if the optical connector 9 is to be incorrectly connected to the two adjacent optical connectors 3 by straddling thereover instead of being connected to the one optical connector 3 to be connected, the magnet 5a and the terminal-side magnet 11b face each other and the magnet 5b and the terminal-side magnet 11a face each other. Thus, repulsive force is generated between the respective magnets, thereby suppressing the incorrect connection. As above, in the present embodiment, when connecting the one optical connector 3 and the optical connector 9, the magnets 5a and 5b of the one optical connector 3 and the terminal-side magnets 11a and 11b of the optical connector 9 are attracted to each other to be connected. Also, it is possible to cause the magnet 5a or magnet 5b of the other optical connector 3, which are adjacent to the magnets of the one optical connector 3, to repel the terminal-side magnet 11b or the terminal-side magnet 11a of the optical connector 9.

Also, the polarities of the terminal-side magnets 11a and 11b on both sides of the width direction of the optical connector 9 that is to be connected to the optical connector 3 are opposite to each other. Thus, with respect to the width direction of the optical connector 9, the polarity (an N pole) of the terminal-side magnet 11a on one side affecting a rear side of the optical connector 9 is the same as the polarity (an N pole) of the terminal-side magnet 11b on the other side affecting a front side of the optical connector 9. That is, when connecting the optical connectors 9 to the optical connectors 3 in sequence, the rear polarity (an S pole) of the terminal-side magnet 11b of the already connected optical connector 9 (the upper optical connector 9 in FIG. 2) and the front polarity (an S pole) of the terminal-side magnet 11a of the optical connector 9 to be connected next (the lower optical connector 9 in FIG. 2) repel each other (an arrow I in the drawing). This can suppress deterioration of connection operation caused by the optical connector 9 being attracted to the adjacent optical connector 9 when connecting the optical connector 9 to the optical connector 3.

For example, if the front polarity of the terminal-side magnet 11a of the optical connector 9 to be connected next (the lower optical connector 9 in FIG. 2) is an N-pole with respect to the rear magnetic polarity (an S pole) of the terminal-side magnet 11b of the already connected optical connector 9 (the upper optical connector 9 in FIG. 2), such the terminal-side magnets 11a and 11b attract each other. This obstructs the operation of connecting the optical connector 9 to the optical connector 3. In contrast, making the adjacent optical connectors 9 repel each other facilitates the operation of connection to the optical connector 3.

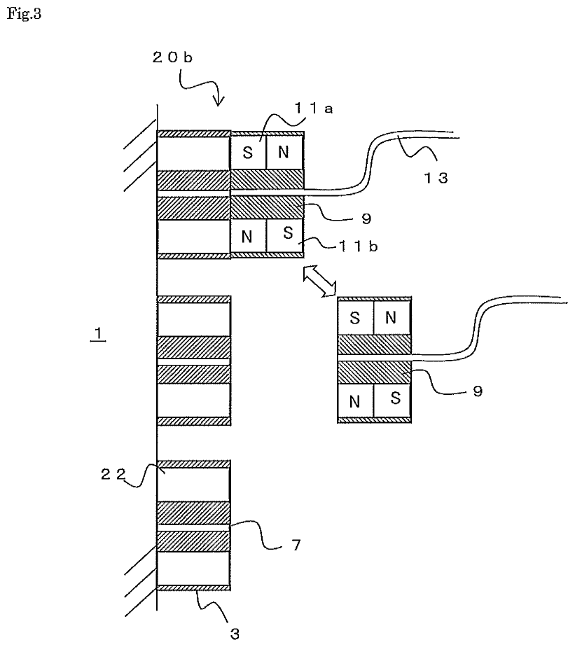

If there is no need to obtain an effect of suppressing the optical connector 9 from being incorrectly connected by straddling to the optical connectors 3 and it is the only purpose to suppress attraction between the adjacent optical connectors 9 when connecting the optical connector 9 to the optical connector 3, it is not always necessary to dispose the magnets in the optical connector 3. For example, as shown in FIG. 3, a magnetic body 22, which is a strong magnetic body (preferably a soft magnetic body) may be disposed in the optical connector 3 so as to attract the terminal-side magnets 11a and 11b in the optical connector 9.

Also in such the case, with respect to the width direction of the optical connector 9, the polarity (an N pole) of the terminal-side magnet 11a on the one side affecting the rear side of the optical connector 9 is made to be the same as the polarity (an N pole) of the terminal-side magnet 11b on the other side affecting the front side of the optical connector 9, and this can suppress deterioration of the connection operation caused by being attracted to the adjacent optical connector 9 when connecting the optical connector 9 to the optical connector 3.

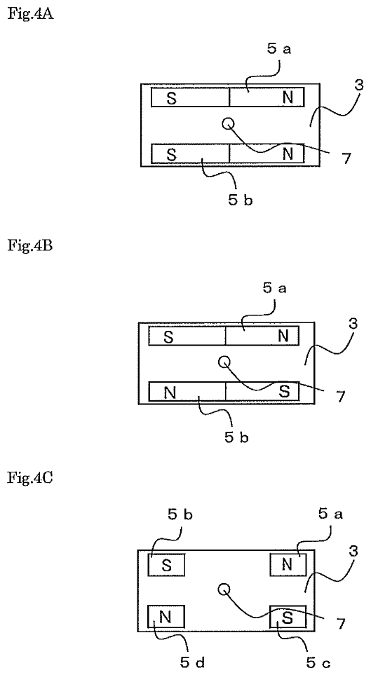

When disposing the magnets 5a and 5b in the optical connector 3, the arrangement of the magnets 5a and 5b is not limited to the example shown in FIG. 1B. For example, as shown in FIG. 4A, the magnets 5a and 5b may be disposed above and below the optical waveguide 7, respectively. That is, the magnets 5a and 5b may be disposed at an upper part and a lower part of a height direction that is perpendicular to the width direction of the optical connector 3.

In the example shown in FIG. 4A, both the magnets 5a and 5b are disposed respectively such that the N poles face toward one side of the width direction of the optical connector 3 (the right direction in the drawing) and the S poles face toward the other side (the left side in the drawing). Even in such the case, the N poles are disposed vertically on the one side of the width direction of the optical connector 3 and the S poles are disposed vertically on the other side of the width direction. Thus, the same function as shown in FIG. 1B can be performed.

Also, as shown in FIG. 4B, as opposed to FIG. 4A, the directions of the upper and lower magnets 5a and 5b may be reversed. That is, the magnet 5a is disposed such that the N pole faces toward one side of the width direction of the optical connector 3 (the right direction in the drawing) and the S pole faces toward the other side (the left side in the drawing). Also, the magnet 5b is disposed such that the S pole faces toward one side of the width direction of the optical connector 3 (the right direction in the drawing) and the N pole faces toward the other side (the left side in the drawing).

Also in such the case, the polarities of the magnets 5a and 5b that are adjacent to each other straddling the adjacent optical connectors 3 are opposite to each other. Thus, it is possible to suppress incorrect connection of the optical connector 9 to the adjacent optical connectors 3 by straddling.

Also, as shown in FIG. 4C, instead of making the N pole and S pole of the magnets face in the width direction of the optical connector 3, respectively, the respective magnets may be disposed such that one of the polarities face toward the connection direction as shown in FIG. 1A. In the example shown in FIG. 4C, magnets 5a, 5b, 5c, and 5d are disposed at four corners of the optical connector 3, respectively. On the one side of the width direction of the optical connector 3 (the right direction in the drawing), the N pole of the upper magnet 5a faces the connection direction, and the S pole of the lower magnet 5c faces the connection direction. Similarly, on the other side of the width direction of the optical connector 3 (the left direction in the drawing), the S pole of the upper magnet 5b faces the connection direction and the N pole of the lower magnet 5d faces the connection direction.

Even in such the case, the polarities of the magnets 5a and 5c of the one optical connector 3 and the polarities of the magnets 5b and 5d of the adjacent other optical connector 3, which are adjacent to the magnets 5a and 5c by straddling, are in opposite directions. Thus, it is possible to suppress incorrect connection of the optical connector 9 to the adjacent optical connectors 3 by straddling.

The arrangements and directions of the magnets are not limited to the examples shown in FIG. 4A to FIG. 4C. Also in the optical connector 9 to be connected, in each of the above-mentioned embodiments, the terminal-side magnets are disposed in the respective corresponding arrangements and directions in accordance with the various types of arrangements and directions of the magnets in the optical connector 3 to be connected.

As above, according to the present embodiment, the respective magnets of the optical connector 3 and the terminal-side magnets of the optical connector 9 to be connected attract each other so that the optical device 1 (the optical connector 3) and the optical connector 9 are optically connected. This facilitates attaching and detaching of the optical connector 9 to and from the respective optical connectors 3. Also, with respect to the side-by-side direction of the optical connectors 3, the polarities of the adjacent magnets that are disposed straddling the adjacent optical connectors 3 are opposite, and this can suppress incorrect connection of the optical connector 9 to the adjacent optical connectors 3 by straddling.

Also, at the time of connection operation, the terminal-side magnets of the adjacent optical connectors 9 are made to repel each other (e.g., by making the polarity of the terminal-side magnet of the already connected optical connector 9 affecting the rear side same as the polarity of the terminal-side magnet of the optical connector 9 to be connected next affecting the front side), and this can suppress attraction of the optical connector 9 to be connected to the adjacent optical connector 9, thereby facilitating the connection operation.

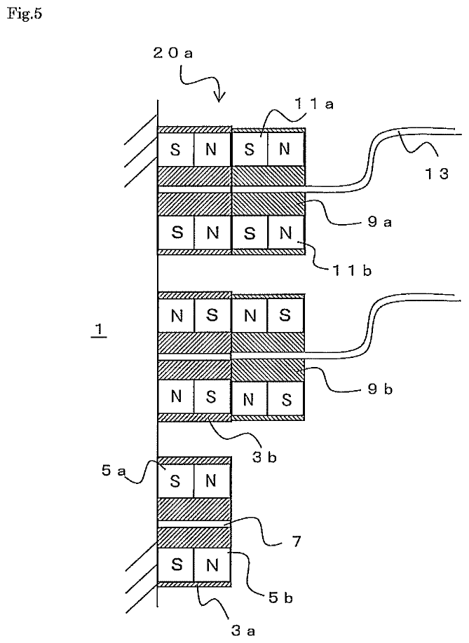

Next, a second embodiment will be described. FIG. 5 is a view showing an optical connector connection structure 20a according to the second embodiment. In the descriptions hereafter, structures performing the similar functions as in the first embodiment will have the same notations as in FIG. 1A to FIG. 4D, and redundant descriptions will be omitted.

The optical connector connection structure 20a is substantially similar to the optical connector connection structure 20 except that a plurality of optical connectors 3a and 3b are alternately provided side by side in the optical device 1. An optical connector 9a is connected to the optical connector 3a, and an optical connector 9b is connected to the optical connector 3b.

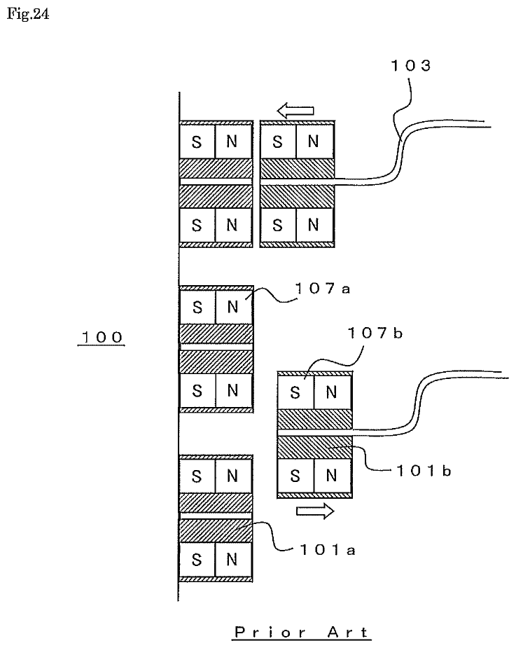

In the optical connector 3a, substantially similarly to the conventional optical connector 101a (FIG. 24), the magnets 5a and 5b on one side and the other side of a width direction of the optical connector 3a are disposed such that the both face toward the same direction. In the illustrated example, both the magnets 5a and 5b are disposed such that N poles thereof face toward the connection direction.

Meanwhile, similarly in the optical connector 3b, the magnets 5a and 5b on one side and the other side of a width direction of the optical connector 3b are disposed such that the both face toward the same direction. In the illustrated example, both the magnets 5a and 5b are disposed such that S poles thereof face toward the connection direction.

Also, similarly in the optical connector 9a that is to be connected to the optical connector 3a, the terminal-side magnets 11a and 11b on one side and the other side of a width direction of the optical connector 9a are disposed such that the both face toward the same direction. In the illustrated example, both the terminal-side magnets 11a and 11b are disposed such that S poles thereof face toward the connection direction.

Also, similarly in the optical connector 9b that is to be connected to the optical connector 3b, the terminal-side magnets 11a and 11b on one side and the other side of a width direction of the optical connector 9b are disposed such that the both face toward the same direction. In the illustrated example, both the terminal-side magnets 11a and 11b are disposed such that N poles thereof face toward the connection direction.

Thus, when the optical connector 3a and the optical connector 9a face each other, the magnets 5a and 5b and the terminal-side magnets 11a and 11b attract each other and thus the optical connector 3a and the optical connector 9a can be connected. Similarly, when the optical connector 3b and the optical connector 9b face each other, the magnets 5a and 5b and the terminal-side magnets 11a and 11b attract each other and thus the optical connector 3b and the optical connector 9b can be connected.

In contrast, if the optical connector 9a, or the optical connector 9b, is to be connected incorrectly to the adjacent optical connectors 3a and 3b by straddling, at least the magnets on one side repel each other. Thus, it is possible to suppress incorrect connection of the optical connectors 9a or 9b to the adjacent optical connectors 3a and 3b by straddling.

According to the second embodiment, the same effects as in the first embodiment can be obtained. By having opposite polarities for the adjacent magnets straddling the adjacent optical connectors, it is possible to suppress incorrect connection of an optical connection terminal, which is to be connected, to the adjacent optical connectors by straddling.

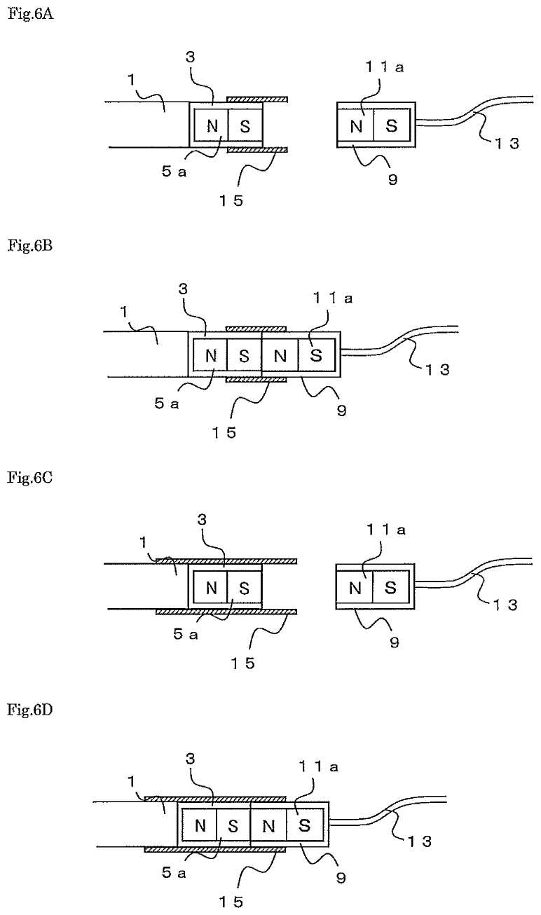

Next, a third embodiment will be described. FIG. 6A is a view showing a state in which the optical connector 3 and the optical connector 9 are disposed facing each other. In the present embodiment, guides 15 are provided above and below the optical connector 3 so as to face each other. The guides 15 are substantially plate-like shaped and protrude toward the connection direction of the optical connector 3, respectively.

As shown in FIG. 6B, when connecting the optical connector 9 to the optical connector 3, firstly, the optical connector 9 is inserted between the guides 15 and the optical connector 9 is pushed along the guides 15 so that the optical connector 3 and the optical connector 9 can be connected. That is, the guides 15 function as guide mechanisms for connecting the optical connector 9 to the optical connector 3.

Instead of fixing the guides 15 to the optical connector 3, the guides 15 may be attached to the optical device 1 (the substrate or the chip) as shown in FIG. 6C. Also in such the case, as shown in FIG. 6D, the optical connector 9 is inserted between the guides 15 first and the optical connector 9 is pushed along the guides 15 so that the optical connector 3 and the optical connector 9 can be connected.

Although the guides 15 have been formed above and below the optical connector 3, the guides 15 may be formed on both sides of the width direction of the optical connector 3. That is, the guides 15 may be disposed facing each other in the side-by-side direction of the optical connector 3 or in the direction perpendicular to the side-by-side direction.

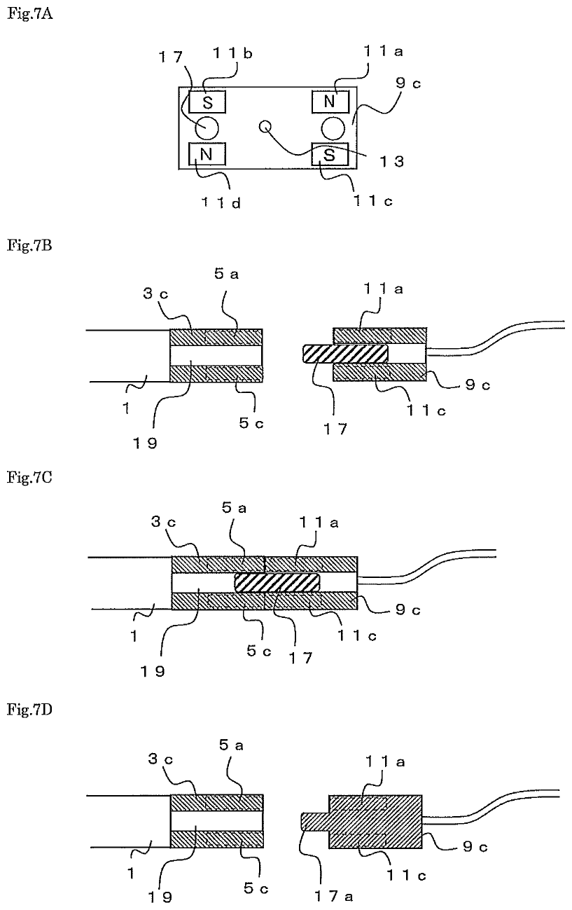

Also, such the guide mechanisms are not limited to the method using the guides 15. FIG. 7A is a front view of an optical connector 9c. In the optical connector 9c, terminal-side magnets 11a, 11b, 11c, and 11d are disposed at four corners thereof, for example. Also, the optical connector 9c is provided with a guide pin 17 on each side of a width direction thereof with the optical fiber 13 in between. The guide pin 17 is inserted into and fixed to a hole formed in the optical connector 9c.

FIG. 7B is a view showing a state in which an optical connector 3c and the optical connector 9c are disposed facing each other. In the optical connector 3c that is to be connected to the optical connector 9c, the magnets 5a, 5b, 5c, 5d are disposed at the four corners as in the optical connector 3 shown in FIG. 4C, and, at the same time, a hole 19 is formed at a part corresponding to the guide pin 17 of the optical connector 9c. That is, the optical connector 3c has the hole 19 on each side of a width direction thereof with the optical waveguide 7 (not shown in the drawing) in between.

As shown in FIG. 7C, when connecting the optical connector 9c to the optical connector 3c, the guide pin 17 of the optical connector 9c is inserted into the hole 19 of the optical connector 3c first and the guide pin 17 is pushed into the hole 19 so that the optical connector 3c and the optical connector 9c can be connected. That is, the guide pin 17 and the hole 19 function as the guide mechanisms for connecting the optical connector 9c to the optical connector 3c.

Instead of the guide pin 17, a boss 17a may be provided in the optical connector 9c as shown in FIG. 7D. That is, in the optical connector 3c, the hole 19 into which the guide pin 17 or the boss 17a can be inserted may be provided.

According to the third embodiment, the same effects as in the first embodiment can be obtained. Also, providing the guides 15 in the optical connector 3c or the hole 19, into which the guide pin 17 or the boss 17a can be inserted, in the optical connector 3c can be used as the guide mechanisms for positioning or for preventing tilting of the optical connectors 9 and 9c.

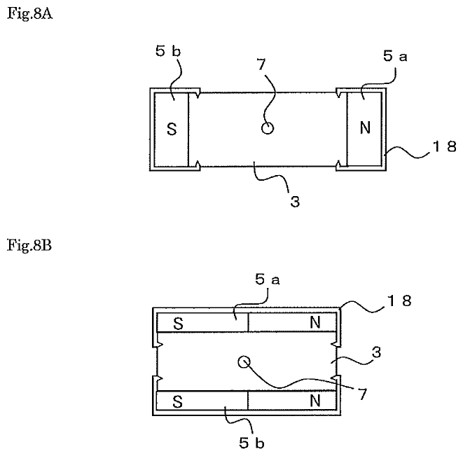

Next, a fourth embodiment will be described. FIG. 8A is a view showing a fixing structure of the magnets 5a and 5b according to the fourth embodiment. In the fourth embodiment, the method for fixing the magnets is different from the above-mentioned embodiments. In the above-mentioned embodiments, the magnets 5a and 5b are fixed to a main body of the connector by embedding or with adhesive etc., whereas clips 18, which are elastic members, are used in the present embodiment.

The clip 18 has a substantially U-shaped cross section and locking hooks formed at both end portions thereof. An opening side of the clip 18 is fitted to each side of the main body of the connector 3 so that the locking hooks are locked into concave portions in the connector main body and the clip 18 is fixed to the connector main body.

The clip 18 is a soft magnetic body including iron, nickel, and cobalt, for example, and has spring properties. The clips 18 cover the magnets 5a and 5b from sides so that the magnets 5a and 5b are fixed to the connector main body. That is, the magnets 5a and 5b are disposed on both sides of a width direction of the connector main body and are fixed to the connector main body with the clips 18 as well as both side faces of the magnets 5a and 5b are covered by the clips 18.

By fixing the magnets 5a and 5b by using the clips 18 in this way, the magnets 5a and 5b can be easily fixed to the connector main body. Also, since the clips 18 are soft magnetic bodies, the clips 18 function as yokes for the magnets 5a and 5b. By placing the yokes near the magnets 5a and 5b in this way, magnetic flux of the magnets 5a and 5b is concentrated inside the yokes without being leaked to the outside. Thus, by concentrating the magnetic flux, attractive force of the magnets 5a and 5b with the connection target can be improved and, at the same time, interference with magnetic flux of the magnets 5a and 5b of the adjacent other optical connectors 3 can be prevented.

The method for fixing the magnets 5a and 5b by the clips 18 may also be a method shown in FIG. 8B. In such the case, the magnets 5a and 5b are disposed above and below the optical connector 3 and the opening sides of the clips 18 are fitted from upper and lower parts of the main body of the optical connector 3 such that the locking hooks are locked into the concave portions of the connector main body and the clips 18 are fixed to the connector main body.

Also in such the case, the magnets 5a and 5b are covered by the clips 18 from the sides and fixed to the connector main body, and the clips 18 can cover the both side faces of the magnets 5a and 5b.

According to the fourth embodiment, the same effects as in the first embodiment can be obtained. Also, fixing the magnets 5a and 5b by using the clips 18 made of soft magnetic bodies enables the clips 18 to function as the yokes.

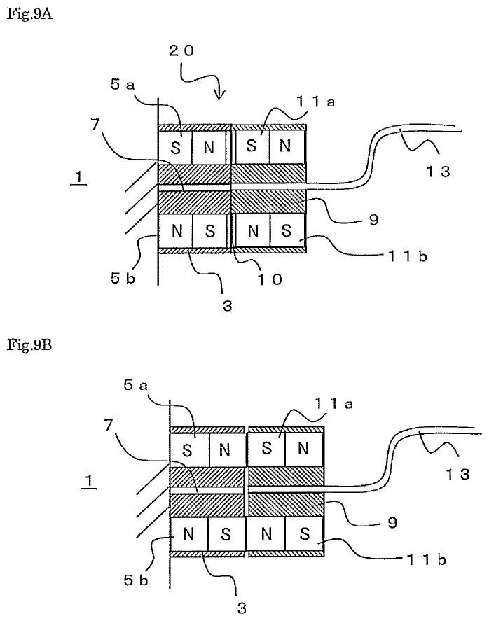

Next, a fifth embodiment will be described. FIG. 9A shows a connection structure of optical connectors according to the fifth embodiment. Also in the present embodiment, the magnets 5a and 5b disposed in the optical connector 3 and the terminal-side magnets 11a and 11b of the optical connector 9 attract each other so that the optical connector 3 and the optical connector 9 are connected to each other. At this time, the present embodiment is designed such that desired optical characteristics can be obtained when end faces of the optical connector 3 and the optical connector 9 are in contact with each other and connected.

Here, in the present embodiment, end faces of the magnets 5a and 5b that are to be disposed in the optical connector 3 are placed at positions that are slightly pulled backward (to an opposite side of the connection direction with the connection target and toward an inner side of the optical connector 3) from the end faces (facing faces with the connection target) of the optical connector 3. Similarly, end faces of the terminal-side magnets 11a and 11b that are to be disposed in the optical connector 9 are placed at positions that are slightly pulled backward (to an opposite side of the connection direction with the connection target and toward an inner side of the optical connector 9) from end faces (facing faces with the connection target) of the optical connector 9. In this way, in a state in which the connection between the optical connector 3 and the optical connector 9 is completed, there is a gap 10 formed between the magnets that attract each other, and the magnets are not in contact with each other.

If the magnets were fixed in a state of being protruded from the end faces of the optical connector, the end faces of the optical connectors would not be in contact with each other and connected with a gap therebetween as shown in FIG. 9B, which makes it impossible to achieve the desirable optical characteristics. Thus, by making the magnets not in contact with each other at the time of connecting the optical connectors together, the end faces of the optical connectors can be in contact with each other with certainty to be connected and the desirable optical characteristics can be obtained. The method for holding the magnets so as not to protrude from the end faces of the optical connector is not limited to the method shown in FIG. 9A.

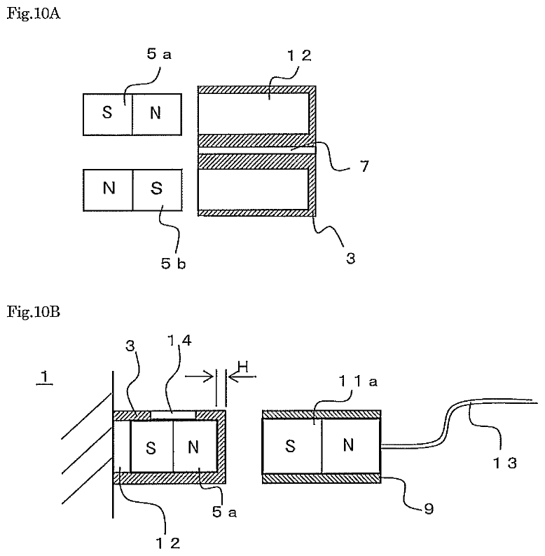

For example, FIG. 10A is a view (a plan cross-sectional view) showing a fixing structure for the magnets 5a and 5b according to another embodiment. In the present embodiment, the method for fixing the magnets 5a and 5b is further different from the above-mentioned embodiments. In the present embodiment, a hole 12, having a predetermined depth, is formed in the optical connector 3 from a rear side (on a side of the optical device, which is the left side in the drawing) toward a front face (on the right side in the drawing), which is a joining face with the optical connection terminal to be connected. That is, the hole 12 is open at the rear side and closed at the front side. The hole 12 is formed at two or four positions depending on the arrangement of the magnets.

FIG. 10B is a view (a side face cross-sectional view) showing a state in which the magnet 5a is inserted into the hole 12 from the rear side and fixed. Although the description hereinafter will be on the magnet 5a as illustrated in the drawing, the same applies to the magnet 5b. As shown in the drawing, the magnet 5a is inserted into the hole 12 to be fixed, and this facilitates positioning of the magnet 5a and thus the magnet 5a can be fixed to the optical connector 3 with certainty.

On an upper face of the optical connector 3, an adhesive applying hole 14 that communicates from an outer periphery surface through to the hole 12 is formed. In this way, the magnet 5a is inserted into the hole 12 and adhesive is poured from the adhesive applying hole 14 so that the magnet 5a and the optical connector 3 can be easily fixed to each other with the adhesive.

Here, since the hole 12 is closed on the front side, the magnet 5a is fixed to the optical connector 3 with a front end face of the magnet 5a being at a position that is pulled back toward the inner side of the optical connector 3 for a predetermined distance (H in the drawing) from the front face of the optical connector 3. That is, the magnet 5a can be fixed being away from the front end face of the optical connector 3 for a thickness at the front side of the hole 12. In this way, the attractive force of the magnet 5a can be adjusted, thereby suppressing impact at the time of attraction with the terminal-side magnet 11a of the optical connector 9 to be connected.

Here, the distance H between the front end face of the magnet 5a (5b) and the front face of the optical connector 3 is preferably between 0.01 mm and 0.5 mm. As mentioned above, to suppress sharp rise in the magnetic force at the time of an approach of the terminal-side magnet 11a, the distance H is preferably 0.01 mm or more. On the other hand, if the distance is more than 0.5 mm, it is difficult to obtain sufficient attractive force. Note that the gap 10 in FIG. 9A preferably has the similar distance as the distance H.

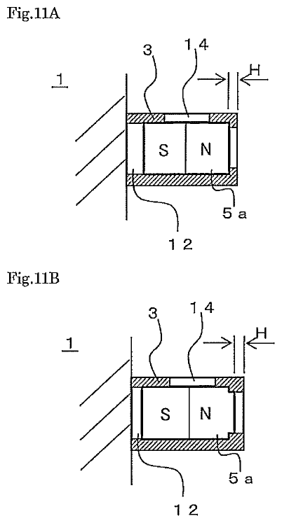

The hole 12 may be a through hole to the front side as shown in FIG. 11A. As mentioned above, the distance H from the front end face of the optical connector 3 is defined by the thickness of the connector main body that closes the hole 12. If the connector main body is to be manufactured by injection molding, resin must flow inside an extremely narrow cavity to make the thickness between 0.01 mm and 0.5 mm, which deteriorates manufacturability. In contrast, forming a reduced-diameter portion that can just perform positioning of the magnet 5a at the front side of the hole 12 can shorten the flow length of the resin and improve the manufacturability of the connector main body. Even in such the case, a diameter of the hole 12 is reduced at the front end portion of the optical connector 3, and thus the magnet 5a can be positioned by level difference of the reduced-diameter portion and the above-mentioned distance H can be obtained.

Also, as shown in FIG. 11B, a diameter of the end of the magnet 5a may be reduced to fit into a part penetrating to the end of the hole 12. Also in this way, the magnet 5a can be positioned, and the magnet 5a can be fixed to the optical connector 3 with more certainty.

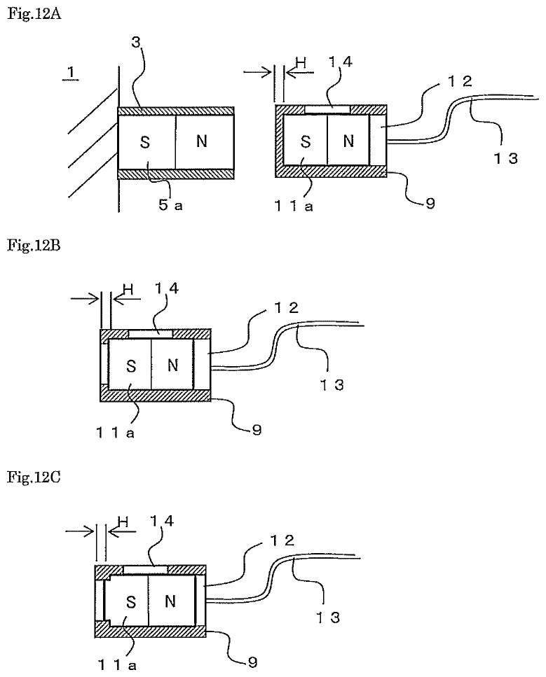

Also, as shown in FIG. 12A, the optical connector 9 that is to be connected to the optical connector 3 may have the similar structure. In such the case, the hole 12, having the predetermined depth, is formed from the rear side of the optical connector 9 (the right direction in the drawing) toward the front face, which is the joining face with the optical connector 3 (the left direction in the drawing). The terminal-side magnet 11a is inserted from the rear side into the hole 12. At this time, the terminal-side magnet 11a is fixed to the optical connector 9 such that the front end face of the terminal-side magnet 11a is at a position that is pulled back toward the inner side of the optical connector 9 for the predetermined distance (H) from the front face of the optical connector 9.

Also in such the case, the adhesive applying hole 14 that communicates from an outer periphery surface through to the hole 12 is formed on an upper face of the connector 9, and adhesive is applied through the adhesive applying hole 14 so that the terminal-side magnet 11a and the optical connector 9 can be fixed to each other with the adhesive.

Also in such the case, the distance H between the front end face of the terminal-side magnet 11a and the front face of the optical connector 9 is preferably between 0.01 mm and 0.5 mm.

Also, the hole 12 may be a through hole to the front side as shown in FIG. 12B. Even in such the case, the diameter of the hole 12 is reduced at the front end portion of the optical connector 9, and thus the terminal-side magnet 11a can be positioned by level difference of the reduced-diameter portion and the above-mentioned distance H can be obtained.

Also, as shown in FIG. 12C, a diameter of the end of the terminal-side magnet 11a may be reduced to fit into the part penetrating to the end of the hole 12. Also in this way, the terminal-side magnet 11a can be positioned, and the terminal-side magnet 11a can be fixed to the optical connector 9 with more certainty. Instead of forming the hole 12 on either one of the optical connectors 3 and 9, the both may have the hole 12 formed to have the same structure.

According to the fifth embodiment, the same effects as in the first embodiment can be obtained. Also, by inserting the magnets 5a and 5b and the terminal-side magnets 11a and 11b into the holes 12, the magnets can be positioned and can be fixed to the connector main bodies with certainty. At this time, providing the adhesive applying hole 14 facilitates fixing of the magnets. Also, the end faces of the magnets are not exposed to the connection face and are disposed at positions pulled backward so that the attractive force of the magnets can be adjusted.

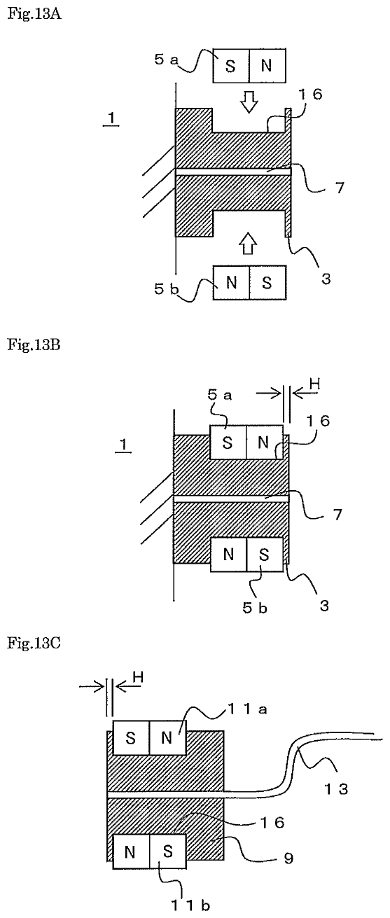

Next, a sixth embodiment will be described. FIG. 13A is a view (a plan cross-sectional view) showing a structure for fixing the magnets 5a and 5b according to the sixth embodiment. In the sixth embodiment, the method for fixing the magnets 5a and 5b is further different from the above-mentioned embodiments. In the present embodiment, a concave portion 16 is formed on the outer periphery surface of the optical connector 3. As shown in FIG. 13B, the magnets 5a and 5b are fitted into the concave portions 16 to be fixed to the optical connector 3. Adhesive or the like is used to fix the magnets 5a and 5b.

At this time, similarly to the fifth embodiment, the magnets 5a and 5b are fixed to the optical connector 3 such that the front end faces of the magnets 5a and 5b are at the positions that are pulled back toward the inner side of the optical connector 3 for the predetermined distance (H in the drawing) from the front face of the optical connector 3. Also in such the case, the distance H between the front end faces of the magnets 5a and 5b and the front face of the optical connector 3 is preferably between 0.01 mm and 0.5 mm.

Also, as shown in FIG. 13C, the optical connector 9 may have the similar structure. That is, the concave portions 16 may be formed on the outer periphery surface of the optical connector 9 and the terminal-side magnets 11a and 11b may be fitted into the concave portions 16 to be fixed.

According to the sixth embodiment, the same effects as in the fifth embodiment can be obtained. Also, by fitting the magnets 5a and 5b and the terminal-side magnets 11a and 11b into the concave portions 16, the magnets can be positioned with certainty and can be easily fixed to the connector main bodies. At this time, manufacturing the connectors with the concave portions 16 is easier compared to the case in which the holes 12 are formed.

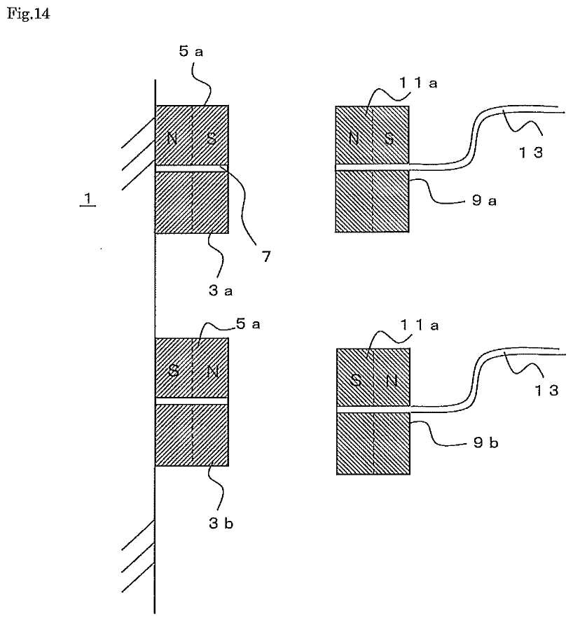

Next, a seventh embodiment will be described. FIG. 14 is a view showing a connection structure between the optical connectors 3a and 3b and the optical connectors 9a and 9b according to the seventh embodiment. In the present embodiment, materials forming the optical connectors 3a and 3b are made of magnetic resin, and main bodies of the optical connectors 3a and 3b themselves are made of the magnets 5a. Similarly, materials forming the optical connectors 9a and 9b are made of magnetic resin, and main bodies of the optical connectors 9a and 9b themselves are made of the terminal-side magnets 11a.

The magnetic resin uses a material made by mixing magnetic material powder and binder material powder such as resin, which is processed by magnetic field molding. The magnetic material includes, for example, a ferrite group, a neodymium group, and a samarium-cobalt group, and the binder material such as nylon or PPS may be applied.

Also in such the case, the polarities of the one optical connector 3a are different from the polarities of the other optical connector 3b that is adjacent to the one optical connector 3a. That is, the optical connectors 3a and 3b are alternately disposed side-by-side. Thus, incorrect connection between the connectors can be suppressed.

According to the seventh embodiment, the same effects as in the first embodiment can be obtained. Also, since the connector main bodies themselves are made of magnetic resin, there is no need to fix magnets to the connector main bodies. In the above embodiment, an example in which the optical connectors 3a and 3b and the optical connectors 9a and 9b are all made of the magnetic resin has been shown. However, only either of the connectors may be made of magnetic resin and the magnets may be fixed to the connector main bodies for the others by using the above-mentioned various methods.

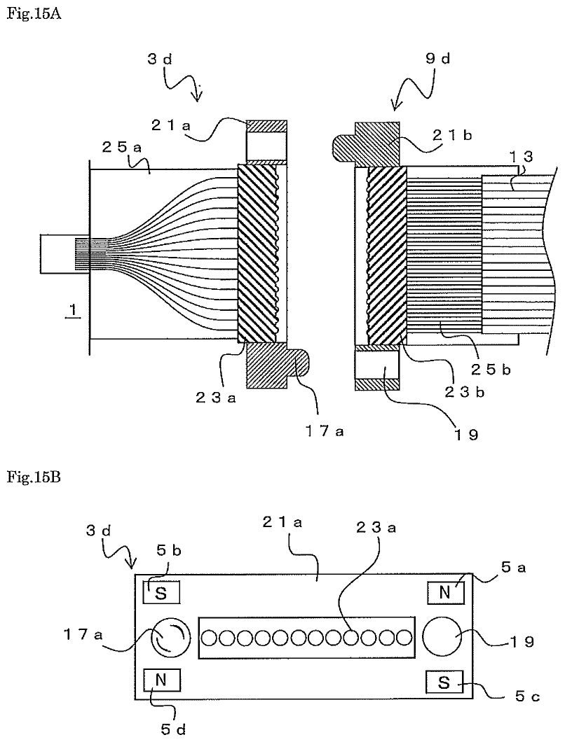

Next, an eighth embodiment will be described. FIG. 15A is a cross-sectional view of a state in which an optical connector 3d and an optical connector 9d according to the eighth embodiment face each other, and FIG. 15B is a front view of the optical connector 3d.

A through hole is provided in the middle of a positioning member 21a, and a lens array 23a is accommodated and fixed with adhesive, for example, inside the through hole of the positioning member 21a. At this time, the lens array 23a is positioned and fixed at a predetermined position with respect to the positioning member 21a.

The lens array 23a is optically connected to a planar waveguide 25a, which is an optical waveguide member. A plurality of optical waveguide paths are formed in the planar optical waveguide 25a, and lenses of the lens array 23a and the optical waveguide paths are aligned, optically connected, and fixed with adhesive, for example, respectively. Here, it is preferable that the planar optical waveguide 25a and the lens array 23a are made of silicon or glass and the positioning member 21a is made of thermoplastic resin.

A substrate is optically connected to a rear of the planar optical waveguide 25a via a photonic integrated circuit or the like, for example. On a front face of the positioning member 21a (a face facing the optical connector 9d), a boss 17a and a hole 19 as the guide mechanisms for the optical connector 9d are provided on each side of the lens array 23a. In addition, the magnets 5a, 5b, 5c, and 5d are disposed on the front face of the positioning member 21a of the optical connector 3d. That is, just like the optical connector 3 shown in FIG. 4D, the plurality of magnets 5a, 5b, 5c, and 5d are disposed at proximities of four corners of the positioning member 21a, respectively.

The optical connector 9d has a substantially similar structure as the optical connector 3d. A lens array 23b is accommodated and fixed inside a positioning member 21b. At this time, the lens array 23b is positioned at a predetermined position and fixed with adhesive, for example, to the positioning member 21b.

The lens array 23b is optically connected to an optical fiber array 25b. The optical fiber array 25b includes a plurality of optical fibers 13 that are arranged in parallel at predetermined intervals by a holding member having holes or V-shaped grooves. Each lens of the lens array 23b is aligned and optically connected with each of the optical fibers 13 and fixed with adhesive, for example. It is preferable that the optical fiber array 25b and the lens array 23b are made of glass and the positioning member 21b is made of thermoplastic resin.

Also, on a front face of the positioning member 21b of the optical connector 9d, terminal-side magnets, of which illustrations are omitted, are disposed at positions corresponding to the magnets 5a, 5b, 5c, and 5d of the optical connector 3d, respectively. That is, just like the optical connector 3 shown in FIG. 4C, the plurality of terminal-side magnets are disposed at proximities of four corners of the positioning member 21b, respectively.

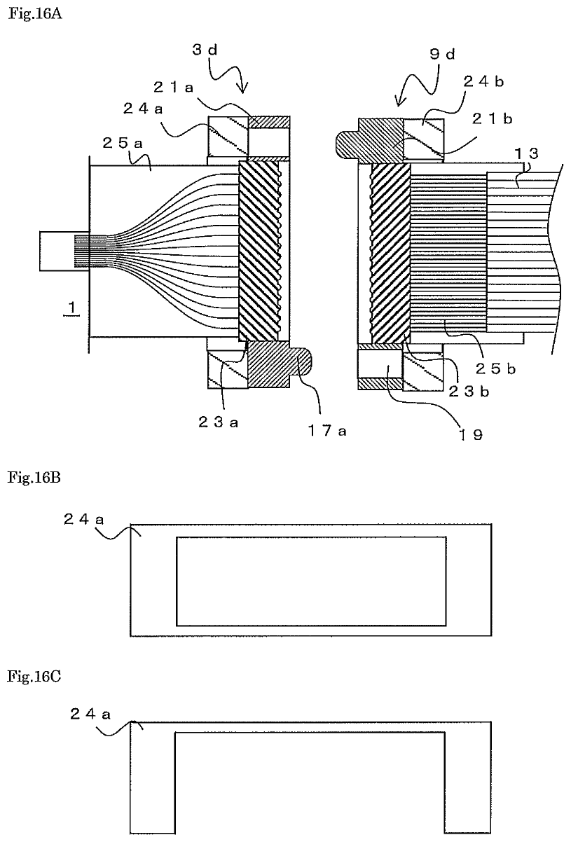

At this time, as shown in FIG. 16A, a yoke 24a may be fixed to the positioning member 21a and a yoke 24b may be fixed to the positioning member 21b. The yokes 24a and 24b are magnetic bodies, and, by placing the yokes 24a and 24b near the magnets of the optical connector 3d and the terminal-side magnets of the optical connector 9d, respectively, magnetic flux of each magnet is concentrated inside the yokes without being leaked to the outside. Thus, by concentrating the magnetic flux, attractive force of the magnets with the connection target can be improved.

The yokes 24a and 24b may be disposed on rear sides of the positioning members 21a and 21b (on the sides opposite to respective connection directions) as shown in the drawing, or may be disposed on sides of the positioning members 21a and 21b. Also, the yoke 24a may be in a frame-like shape surrounding the lens array etc. from circumference as shown in FIG. 16B, or may be in a shape with an opening on one side as shown in FIG. 16C. The same applies to the yoke 24b.

The boss 17a and the hole 19 for positioning with the optical connector 3d are provided on the front face of the positioning member 21b (the face facing the optical connector 3d). When the optical connector 3d and the optical connector 9d are positioned by the guide mechanisms and connected by the magnets, the lens array 23a and the lens array 23b are optically connected via a predetermined gap.

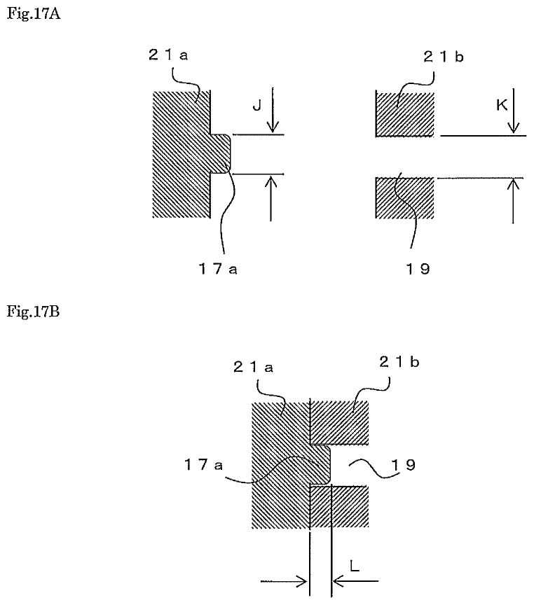

FIG. 17A is a view showing detail of the boss 17a provided on the front face of the positioning member 21a and the hole 19 provided on the positioning member 21b. Note that the optical connectors 3d and 9d may have the guide pin 17 (see FIG. 7B) in place of the boss 17a as the guide mechanism. Also, the holes 19 may be formed on both sides of the optical connector 3d, and bosses or guide pins may be disposed on both sides of the optical connector 9d. That is, one of the optical connector 3d and the optical connector 9d may be provided with guide pins or bosses, and the other of the optical connector 3d and the optical connector 9d may be provided with holes into which the guide pins or bosses can be inserted. As above, the guide mechanisms for the optical connector 3d and the optical connector 9d are not specifically limited.

An outer diameter J of the boss 17a is smaller than an inner diameter K of the hole 19. At this time, it is preferable that a difference between the outer diameter J of the boss 17a and the inner diameter K of the hole 19 is 0.005 mm or less, or more preferably 0.002 mm or less. In this way, positioning effects with higher precision can be achieved.

FIG. 17B is a view showing a state in which the boss 17a is inserted into the hole 19a and facing faces of the positioning members 21a and 21b are in contact with each other (a state in which the optical connector 3d and the optical connector 9d are connected). An insertion length L of the boss 17a into the hole 19 when the optical connector 3d and the optical connector 9d are connected is preferably 0.05 mm or more and 0.60 mm or less, or more preferably 0.10 mm or more and 0.30 mm or less. If the insertion length L is large and the optical connectors are connected being slanted, the boss 17a may be inserted into the hole 19 at an angle, which makes it difficult to connect the connectors. Thus, a length of the boss or the guide pin protruding from the main body of the connector is preferably within the predetermined range. The same descriptions on the above dimensions or the like of the guide pin or boss and the hole also apply to FIG. 7A to FIG. 7D.

The respective magnets in the positioning member 21a and the respective terminal-side magnets in the positioning member 21b in the present embodiment may also be disposed at positions that are pulled back from the end faces of the respective positioning members toward the inner side of the positioning members as shown in FIG. 9A. That is, in FIG. 15A, when the optical connectors 3d and 9d are connected, the end faces of the positioning members 21a and 21b are in contact with each other to be held, and thus the designed connection state can be achieved and desirable optical characteristics can be obtained. At this time, the facing magnets are not in contact with each other but are held with a gap in between.

According to the eighth embodiment, the same effects as in the first embodiment can be obtained. As above, the optical connector may have the plurality of built-in optical waveguides and, at this time, the lens array may be disposed and the optical connector may be connected via the lens array to the optical connector 9d to be connected.

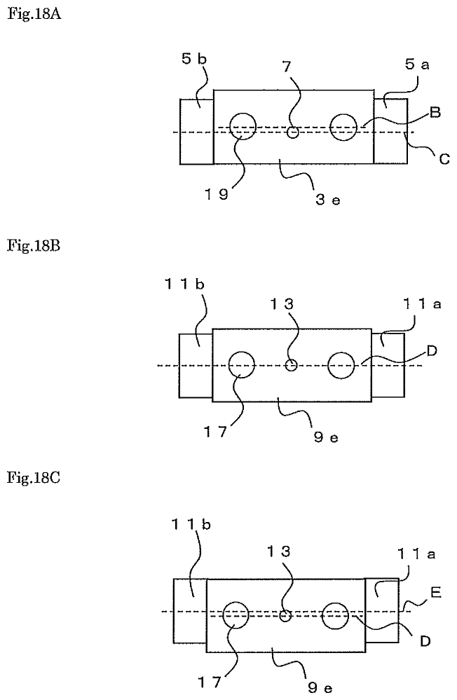

Next, a ninth embodiment will be described. FIG. 18A is a front view showing an optical connector 3e according to the ninth embodiment. In the optical connector 3e, the arrangement of the magnets 5a and 5b is different from the above-mentioned embodiments.

The optical connector 3e includes the holes 19, as the guide mechanisms, formed on both sides of the optical waveguide 7. Also, in the optical connector 3e, the magnets 5a and 5b are disposed on both sides of the width direction of the connector main body. Here, with respect to a height direction of the optical connector 3e, a centerline of the holes 19 (B in the drawing) coincides with a centerline of the height direction of the connector main body.

On the other hand, the magnets 5a and 5b are shorter in height than the connector main body, and the magnets 5a and 5b are disposed such that lower ends of the magnets 5a and 5b are at the same level with a lower end of the connector main body. Thus, a centerline in the height direction of the magnets 5a and 5b (C in the drawing) is at a lower position than the centerline B of the connector main body (the holes 19). As above, the centerline C in the height direction of the magnets 5a and 5b on the left and right is misaligned with the centerline B of the connector main body (the holes 19) in the height direction.

Also, in the optical connector 3e, a center position in a height direction of the optical waveguide 7 substantially coincides with the centerline C of the magnets 5a and 5b. That is, a center position of the optical waveguide 7 and center positions of the holes 19 are misaligned in the height direction of the optical connector 3e.

FIG. 18B is a front view of an optical connector 9e that is to be connected to the optical connector 3e. Like the optical connector 3e, the optical connector 9e also includes the terminal-side magnets 11a and 11b disposed on both sides of the width direction of the connector main body. Also, as mentioned above, the guide pins 17 that are to be inserted into the holes 19 of the optical connector 3e are disposed on the optical connector 9e. In place of the guide pins 17, the bosses 17a may also be used.

In the optical connector 9e, a centerline in the height direction of the optical fiber 13 and the guide pin 17 coincides with a centerline D in the height direction of the connector main body. Also, in the optical connector 9e, a centerline of the terminal-side magnets 11a and 11b in the height direction is disposed so as to substantially coincide with the centerline of the connector main body. That is, in FIG. 18B, the terminal-side magnets 11a and 11b are disposed at a substantial center of the height direction of the connector main body.

For the optical connector 9e, an arrangement of the terminal-side magnets 11a and 11b in the height direction may be shifted from the center of the height direction of the connector main body as shown in FIG. 18C. In the illustrated example, the terminal-side magnets 11a and 11b have shorter heights than the height of the connector main body and are disposed such that upper ends of the terminal-side magnets 11a and 11b coincide with an upper end of the connector main body. Thus, a centerline of the terminal-side magnets 11a and 11b in the height direction (E in the drawing) is at a higher position than the centerline D of the connector main body (the guide pin 17 and the optical fiber 13) in the height direction.

In this way, the center position of the terminal-side magnets 11a and 11b in the height direction in the optical connector 9e is disposed so as to substantially coincide with the center of the connector main body in the height direction or to be above the centerline of the connector main body. That is, an arrangement of the terminal-side magnets in the optical connector 9e (above the connector main body) is disposed to be different from the arrangement of the magnets 5a and 5b (below the connector main body) in the optical connector 3e to be connected.

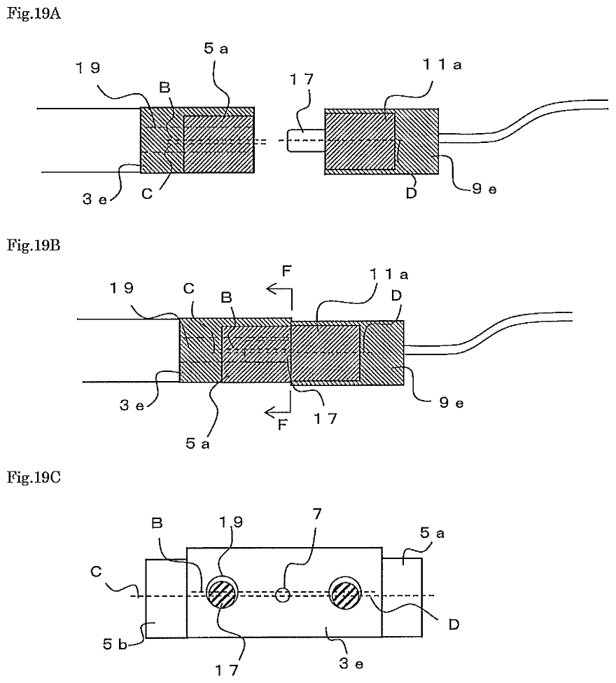

FIG. 19A is a view showing a state in which the optical connector 3e and the optical connector 9e are disposed facing each other. Although the one shown in FIG. 18B will be described as the optical connector 9e, the same applies to the one shown in FIG. 18C. Also, in FIG. 19A to FIG. 19C, the lines B, C, and D show the same centerlines B, C, and D in FIG. 18A and FIG. 18B. When the guide pin 17 is inserted into the hole 19, the centerline D of the guide pins 17 and the centerline B of the holes 19 are aligned at the substantially same position to perform the connection operation.

FIG. 19B is a view showing a state in which the optical connector 3e and the optical connector 9e are connected. In a state in which the guide pin 17 of the optical connector 9e is inserted into the hole 19 of the optical connector 3e to be positioned, the magnet 5a and the terminal-side magnet 11a (and the magnet 5b and the terminal-side magnet 11b) attract each other so that the optical connector 3e and the optical connector 9e are connected.

FIG. 19C is a cross-sectional view taken along F-F line in FIG. 19B (a front view of the optical connector 3e in a connected state). Here, to enable the guide pin 17 to be inserted into the hole 19 with small force, the outer diameter of the guide pin 17 is to be a predetermined amount smaller than the inner diameter of the hole 19 so as to form a clearance. On the other hand, if the clearance becomes large, there may be core misalignment between the optical waveguide and the optical fiber to be optically connected, which may cause transmission loss.

On the other hand, if the magnet 5a (5b) and the terminal-side magnet 11a (11b) are attracted each other, magnetic force is strongest at each of the centers thereof and thus the magnet 5a (5b) and the terminal-side magnet 11a (11b) are attracted such that the centers thereof substantially coincide with each other. That is, as shown in FIG. 19B, the connectors are connected such that the centerline D of the terminal-side magnets 11a and 11b coincides with the centerline C of the magnets 5a and 5b.

Also, in the present embodiment, the centerline C of the magnets 5a and 5b is misaligned with the centerline B of the holes 19. Thus, as shown in FIG. 19C, if the magnets are attracted to each other such that the centerline C of the magnets 5a and 5b coincides with the centerline D of the terminal-side magnets 11a and 11b, the centerline D of the guide pin 17 and the optical fiber 13 in the optical connector 9e is misaligned with the centerline B of the holes 19 of the optical connector 3e. As a result, the guide pin 17 is in a state of being pressed against a lower part of the hole 19.

In such the state, the centerline C of the optical waveguide 7, which substantially coincides with the centerline of the magnets 5a and 5b, substantially coincides with the centerline D of the optical fiber 13. That is, the optical connector 3e and the optical connector 9e are connected with high precision. As above, even if there is a clearance between the guide pin 17 and the hole 19, it is possible to keep the position of the guide pin 17 inside the hole 19 constant and thus the optical connection with precision can be performed.

That is, in the present embodiment, when connecting optical connectors having the guide mechanisms of guide pins (or bosses, the same applies hereafter) and holes, a center position of the optical waveguide and a center position of the magnets of one of the connectors coincides with each other in the height direction (the centerline C in FIG. 18A). Also, the centerline C is disposed being shifted (e.g., downward) from the center position of the guide pins (or the holes) (the centerline B in FIG. 18A). Meanwhile, center positions of the optical waveguide, the magnets, and the holes or the guide pins of the other optical connector (the centerline D in FIG. 18B) are made to coincide with each other in the height direction. Alternatively, the center position of the magnets of the other optical connector in the height direction (the centerline E in FIG. 18C) is disposed being shifted from the center position of the optical waveguide and the holes (or the guide pins) in the height direction (the centerline D in FIG. 18C) in an opposite direction to the one optical connector (e.g., upward). As mentioned above, the magnets attract each other so that the central axes thereof are naturally aligned, and thus the connection can be performed in a state in which the holes and guide pins are pressed in one direction of the height direction.

To obtain the above effects, it is preferable to increase, rather than the clearance between the hole and the guide pin, an amount of misalignment between center axes of the above-mentioned one optical connector (misalignment between the centerline B and the centerline C in FIG. 18A). Also, an arrangement of the optical waveguide 7 in the height direction may be set to coincide with the optical fiber (the optical waveguide) on the side of the optical connector 9e in a state in which the guide pin 17 is pressed to the lower (or upper) part of the hole 19.

According to the ninth embodiment, the same effects as in the first embodiment can be obtained. As above, the central axes positions of the magnets are disposed to be misaligned from the central axes of the guide mechanisms and the like, and thus the optical connection with high precision can be performed.

For the purpose of improvement of the precision of the optical connections, the ninth embodiment can be applied to the conventional connection structures (e.g., FIG. 24). That is, if there is no need to obtain the effects of suppressing the above-mentioned incorrect connection, the present embodiment can be applied to other connector structures in which connectors are connected by attraction between magnets, regardless of the polarities of the magnets.

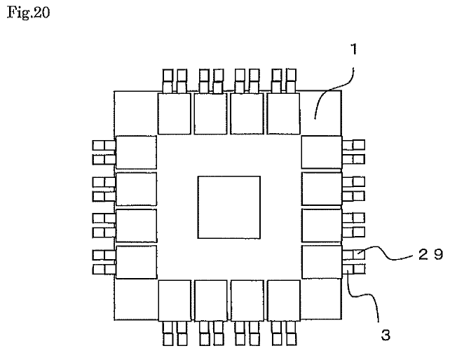

Next, a tenth embodiment will be described. FIG. 20 is a schematic view showing the optical device 1 according to the tenth embodiment. As mentioned above, the plurality of optical connectors 3 are provided side by side in the optical device 1. A chip and the like are installed in the optical device 1 and are connected in a reflow process. As mentioned above, if the optical fibers or the like are already connected in the reflow process, handling performance is poor and there is a risk of damaging the optical connectors. Thus, the optical connectors of the optical fibers are connected to the optical device 1 after the reflow process.

For this reason, magnets to be used in the optical connector 3 are preferably samarium-cobalt magnets having high heat-resistance temperature. In such the case, heat resistance is unnecessary for the terminal-side magnets used for the optical connector 9, and thus inexpensive neodymium magnets may be used. Note that samarium-cobalt magnets are fragile and may break at the time of connecting the optical connectors to each other (at the time of collision between the magnets). Thus, it is preferable to form the gap 10 between the magnets as shown in FIG. 9A.

On the other hand, it is inexpensive if common neodymium magnets can also be used as the magnets used for the optical connector 3. However, as mentioned above, with the heat-resistance temperature of around 80° C., the neodymium magnets may be demagnetized in the reflow process.

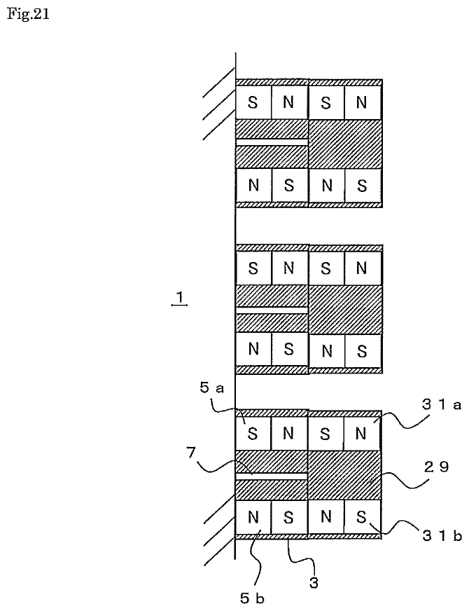

So, in the present embodiment, a protection member 29 is fitted to each optical connector 3 in the reflow process. FIG. 21 is a view showing a state in which the protection member 29 is attached to the optical connector 3. The protection member 29 is large enough to be attached to the optical connector 3 and includes magnets 31a and 31b that are disposed at parts corresponding to the magnets 5a and 5b of the optical connector 3 such that the magnets 31a and 31b can be attracted to the magnets 5a and 5b.

Here, as the magnets 31a and 31b, ferrite magnets or samarium-cobalt magnets having the heat-resistance temperature of around 300° C. are used. That is, magnets having the heat-resistance temperature that is higher than the temperature used in the reflow process are used for the magnets 31a and 31b.

By performing the reflow process in a state in which the magnets having the relatively higher heat-resistance temperature are attracted to the magnets 5a and 5b (neodymium magnets) of the optical connector 3 in this way, demagnetization of the neodymium magnets at high temperatures can be suppressed. Also, covering an exposed face of the optical waveguide 7 by the protection member 29 can suppress contamination etc. of the optical waveguide 7 during the reflow process. After the reflow process, the protection member 29 is removed and the optical connector 9 is connected so as to obtain the optical connection structure. Also, the protection member 29 can be reused for the other optical device that is to be introduced into the reflow process next.

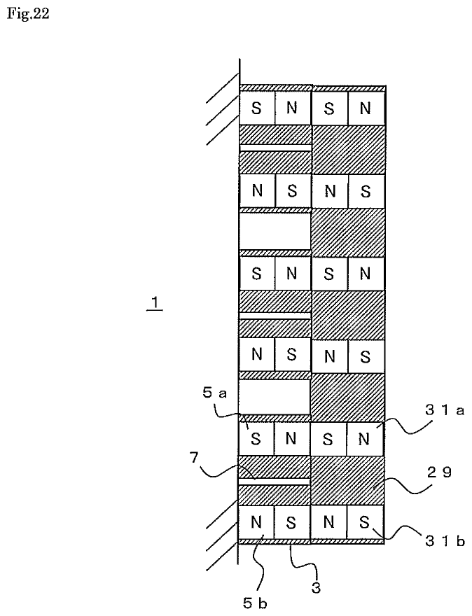

Even in such the case, making the polarities of the magnets 5a and 5b that are disposed straddling the adjacent optical connectors 3 different from one another can suppress incorrect connection of the protection members 29. On the other hand, as the protection member 29, a single magnet of either the magnet 31a or the magnet 31b that can attract the magnets 5a and 5b of the optical connector 3 may be used. Also, as shown in FIG. 22, the protection member 29 may be attached collectively by straddling over the plurality of optical connectors 3.

As above, according to the tenth embodiment, demagnetization in the reflow process can be suppressed even if the inexpensive magnets having the low heat-resistance temperature are used for the optical connector 3.

Note that if there is no need to obtain the effects of suppressing the above-mentioned incorrect connection, the tenth embodiment can be applied to the conventional optical device 100 (FIG. 23 and FIG. 24) for the purpose of suppressing demagnetization of the magnets of the optical connector 3 in the reflow process. That is, if there is no need to obtain the effects of suppressing the above-mentioned incorrect connection, the present embodiment can be applied to other connector structures in which connectors are connected by attraction between magnets, regardless of the polarities of the magnets.

Although the embodiments of the present invention have been described referring to the attached drawings, the technical scope of the present invention is not limited to the embodiments described above. It is obvious that persons skilled in the art can think out various examples of changes or modifications within the scope of the technical idea disclosed in the claims, and it will be understood that they naturally belong to the technical scope of the present invention.

For example, needless to say, the structures in respective embodiments may be combined with one another.

1. An optical device comprising:
a plurality of optical connectors that are provided side by side, wherein magnets are disposed in each of the optical connectors;
polarities of the magnets that are disposed adjacent to each other in the one optical connector and in the other optical connector, which is adjacent to the one optical connector, are different from one another, such that, when connecting the one optical connector to an optical connection terminal to be connected, the magnets of the one optical connector and terminal-side magnets of the optical connection terminal to be connected can attract each other to be connected and, at the same time, the magnets of the other connector, which are adjacent to the magnets of the one connector, can repel the terminal-side magnets of the optical connection terminal to be connected.

2. The optical device according to claim 1, wherein with respect to a side-by-side direction of the optical connectors, the polarities of the magnets on one side of the optical connector are different from the polarities of the magnets on the other side of the optical connector.

3. The optical device according to claim 1, wherein the magnets are disposed on both sides of the side-by-side direction of the optical connectors, respectively.

4. The optical device according to claim 1, wherein the magnets are disposed at an upper part and a lower part of a height direction that is perpendicular to the side-by-side direction of the optical connectors, respectively.

5. The optical device according to claim 1, wherein the optical connector is provided with guide mechanisms for the optical connection terminal to be connected such that the guide mechanisms face each other in the side-by-side direction of the optical connectors or in a direction perpendicular to the side-by-side direction with a center of the optical connector in between.

6. The optical device according to claim 1, wherein the optical connector is provided with a hole into which a guide pin or a boss of the optical connection terminal to be connected can be inserted.

7. The optical device according to claim 1, wherein the magnets are fixed to the optical connector with an elastic member that is formed of a soft magnetic body.

8. The optical device according to claim 1, wherein the optical connector comprises:
a positioning member having guide mechanisms for a connection target;
a lens array that is to be fixed to the positioning member; and
an optical waveguide member that is to be optically connected to the lens array.

9. The optical device according to claim 8, wherein a yoke is fixed to the positioning member.

10. The optical device according to claim 1, wherein the magnets are samarium cobalt magnets.

11. The optical device according to claim 1, wherein:
a hole having a predetermined depth is formed in the optical connector from a rear side toward a front face, which is a joining face with the optical connection terminal to be connected;
the magnet is inserted into the hole; and
the magnet is fixed such that a front end face of the magnet is at a position that is pulled back from the front face of the optical connector toward an inner side of the optical connector for a predetermined distance.

12. The optical device according to claim 11, wherein a distance between the front end face of the magnet and the front face of the optical connector is between 0.01 mm and 0.5 mm.

13. The optical device according to claim 11, wherein:
an adhesive applying hole that communicates from an outer periphery surface through to the hole of the optical connector is formed; and
the magnet and the optical connector are fixed to each other with adhesive at the adhesive applying hole.

14. The optical device according to claim 1, wherein:
a concave portion is formed on the outer periphery surface of the optical connector; and
the magnet is fitted into the concave portion to be fixed.

15. The optical device according to claim 1, wherein:
a material forming the optical connector is made of magnetic resin and a main body of the optical connector itself is formed of a magnet; and
polarities of the one optical connector and polarities of the other optical connector that is adjacent to the one optical connector are different from one another.

16. An optical connector connection structure between the optical device according to claim 1 and an optical connection terminal, wherein the magnets of each of the optical connector and terminal-side magnets of the optical connection terminal to be connected are attracted to each other to be connected.

17. The optical connector connection structure according to claim 16, wherein with respect to a width direction of the optical connection terminal to be connected, a polarity of the terminal-side magnet on one side of the connection terminal affecting a rear side of the optical connection terminal is the same as a polarity of the terminal-side magnet on the other side of the optical connection terminal affecting a front side of the connection terminal.

18. The optical connector connection structure according to claim 17, wherein;
the magnets are samarium-cobalt magnets; and
the terminal-side magnets are neodymium magnets.

19. The optical connector connection structure according to claim 16, wherein when the respective optical connectors are connected to each other, a gap is formed between the magnets and the terminal-side magnets that attract each other so that the magnets and the terminal-side magnets are not in contact with each other.

20. The optical connector connection structure according to claim 16, wherein;
a hole having a predetermined depth is formed in the optical connection terminal from a rear side toward a front face, which is a joining face with the optical connector;
the terminal-side magnet is inserted into the hole; and
the terminal-side magnet is fixed such that a front end face of the terminal-side magnet is at a position that is pulled back from the front face of the optical connection terminal toward an inner side of the optical connection terminal for a predetermined distance.

21. The optical connector connection structure according to claim 19, wherein a distance between the front end face of the terminal-side magnet and the front face of the optical connection terminal is between 0.01 mm and 0.5 mm.

22. The optical connector connection structure according to claim 19, wherein;
an adhesive applying hole that communicates from an outer periphery surface through to the hole of the optical connection terminal is formed; and
the terminal-side magnet and the optical connection terminal are fixed to each other with adhesive at the adhesive applying hole.

23. The optical connector connection structure according to claim 16, wherein:
a concave portion is formed on the outer periphery surface of the optical connection terminal; and
the terminal-side magnet is fitted into the concave portion to be fixed.

24. The optical connector connection structure according to claim 16 wherein:
a material of the optical connection terminal is made of magnetic resin and a main body of the optical connection terminal itself is made of a terminal-side magnet; and
polarities of the one optical connection terminal and polarities of the other optical connection terminal that is adjacent to the one optical connection terminal are different from one another.

25. The optical connector connection structure according to claim 16 wherein:
a guide pin or a boss is provided on each of one ends of the optical connector and the optical connection terminal;
a hole into which the guide pin or the boss can be inserted is formed on each of the other ends of the optical connector and the optical connection terminal; and
an insertion length of the guide pin or the boss in the hole is 0.05 mm or more and 0.60 mm or less.

26. The optical connector connection structure according to claim 25 wherein a difference between an outer diameter of the guide pin or the boss and an inner diameter of the hole is 0.005 mm or less.
